(19) United States
(12) Patent Application Publication
(10) Pub. No.: US 2004/0037626 A1
(43) Pub. Date: Feb. 26, 2004

(54) Mechanisms having motion with constrained degrees of freedom

(76) Inventors: Shorya Awtar, Cambridge, MA (US); Alexander H. Slocum, Bow, NH (US)

Correspondence Address: DALY, CROWLEY & MOFFORD, LLP, SUITE 101, 275 TURNPIKE STREET, CANTON, MA, 02021-2310, US

(21) Appl. No.: 10/228,871

(22) Filed: Aug. 26, 2002

(51) Int. Cl. F16D 1/00

(52) U.S. Cl. 403/223

(57) ABSTRACT

One or more flexures, each having compliant support structures with folded beams, provide a coupling having three degrees of freedom, two couplings having five degrees of freedom, a motion stage having five degrees of freedom, and a motion stage having one degree of freedom.

### CROSS REFERENCE TO RELATED APPLICATIONS

Not Applicable. STATEMENT REGARDING FEDERALLY SPONSORED RESEARCH

Not Applicable.

### FIELD OF THE INVENTION

This invention relates generally to mechanical mechanisms and more particularly to mechanical mechanisms having constrained degrees of freedom.

### BACKGROUND OF THE INVENTION

As is known in the art, reference to “degrees of freedom” is generally understood to include six degrees of freedom. With reference to a Cartesian coordinate these degrees of freedom correspond to linear motion along the x-axis, the y-axis, and the z-axis, and rotational motion about the x-axis, the y-axis, and the z-axis. Any motion can be described as a combination of motions in the six degrees of freedom. As is also know in the art, there exists a class of mechanical mechanisms that provide unconstrained motion in some of the degrees of freedom and constrained motion in others of the degrees of freedom. Various conventional mechanical mechanisms can move in one or more of the six degrees of freedom, while being constrained in others of the six degrees of freedom, such mechanical apparatus referred to herein as constrained apparatus.

For example, one particular conventional constrained apparatus is a linear bearing, in which a carriage or stage, held by constraining slide bushings, can move along only a linear axis. The linear bearing provides one unconstrained degree of freedom along the linear axis and five constrained degrees of freedom.

Another conventional constrained apparatus is a bellows torque coupling for coupling two rotating shafts. Yet another conventional constrained apparatus is a is a helical torque coupling, also for coupling two rotating shafts. Both the bellows torque coupling and the helical torque coupling allow rotational motion about first and second orthogonal axes and linear motion along the first and second orthogonal axes well as along a third axis orthogonal to the first and second axes. The bellows torque coupling and the helical torque coupling are each constrained in rotation about the third orthogonal axis. Thus, the bellows torque coupling and the helical torque coupling each provide five unconstrained degrees of freedom and one constrained degree of freedom.

As is also known, the conventional constrained apparatus has a variety of motion errors. The constrained apparatus can have error motion both in the constrained degrees of freedom and in the unconstrained degrees of freedom. Both error motion in the constrained degrees of freedom and error motion in the unconstrained degrees of freedom are often undesirable.

The error motion in the constrained degrees of freedom can be generated in response to a variety of factors. First, the error motion in the constrained degrees of freedom can be directly generated in response to a force in the direction of the constrained degree of freedom. This motion error is referred to herein as “direct” motion error. For example, the conventional bellows coupling often rotates about the third orthogonal axis in response to a rotational force in that direction, though it is constrained in rotation about the third orthogonal axis. Second, the error motion in the constrained degrees of freedom can be generated in response to motion in an unconstrained degree of freedom. This motion error is referred to herein as “parasitic” motion error. For example, as the helical torque coupling stretches in translation along the third orthogonal axis, the coupling often rotates, or twists, about the third orthogonal axis.

The error motion in unconstrained degrees of freedom can be generated in response to motion in other unconstrained degrees of freedom. This motion error is referred to herein as “coupled” motion error. For example, as the bellows coupling rotates about the first or second orthogonal axis, it often has linear motion along the third orthogonal axis. This linear motion corresponds to an unconstrained degree of freedom.

It would, therefore, be desirable to provide a mechanical apparatus which controls the degrees of freedom, having at least one constrained degree of freedom in which an object motion is reduced. It would also be desirable to provide a mechanical apparatus that minimizes error motion in both constrained and unconstrained degrees of freedom.

### SUMMARY OF THE INVENTION

In accordance with the present invention, a first coupling includes a compliant support structure coupled between a first and a second coupling portion. The compliant support structure can be a planar-compliant support structure, oriented substantially in a support structure plane, or a cylindrical-compliant support structure, having a support structure axis.

With this particular arrangement, the first coupling portion can move with three degrees of freedom relative to the second coupling portion. The three degrees of freedom are relative to a rectangular coordinate system having a z-axis axis parallel to a first coupling portion axis. The three degrees of freedom include linear motion along the z-axis, and rotational motion about each of an x-axis and a y-axis. Constrained degrees of freedom include linear motion along each of the x-axis and the y-axis, and rotational motion about the z-axis. The coupling generates small direct motion errors, substantially no parasitic motion errors, and substantially no coupled motion errors.

In accordance with another aspect of the present invention, a second coupling includes two or more planar-compliant support structures, wherein an intermediate stage is coupled between each adjacent pair of the two or more planar-compliant support structures. A first coupling portion having a coupling portion axis is coupled to one of the planar-compliant support structure and a second coupling portion is coupled to another one of the planar-compliant supports structures.

With this particular arrangement, the second coupling portion can move relative to the first coupling portion with five degrees of freedom. The five degrees of freedom are relative to a rectangular coordinate system having a z-axis parallel to the coupling portion axis and an x-axis and y-axis mutually orthogonal with the z-axis. The five degrees of freedom include linear motion along each of the x-axis, the y-axis and the z-axis, and rotational motion about each of the x-axis and the y-axis. Constrained degrees of freedom include rotational motion about the z-axis. The second coupling generates small direct motion errors, substantially no parasitic motion errors, and substantially no coupled motion errors.

In accordance with yet another aspect of the present invention, a third coupling provides two or more cylindrical-compliant support structures, wherein an intermediate stages is coupled between each adjacent pair of the two or more cylindrical-compliant support structures. A first coupling portion having a coupling portion axis is coupled to one of the cylindrical-compliant support structure and a second coupling portion is coupled to another one of the cylindrical-compliant supports structures.

With this particular arrangement, the second coupling portion can move relative to the first coupling portion with five degrees of freedom. The five degrees of freedom are relative to a rectangular coordinate system having a z-axis parallel to the coupling portion axis and an x-axis and y-axis mutually orthogonal with the z-axis. The five degrees of freedom include linear motion along each of the x-axis, the y-axis and the z-axis, and rotational motion about each of the x-axis and the y-axis. Constrained degrees of freedom include rotational motion about the z-axis. The third coupling generates small direct motion errors, substantially no parasitic motion errors, and substantially no coupled motion errors.

In accordance with yet another aspect of the present invention, a first motion stage includes an intermediate stage having a frame axis, the intermediate frame coupled between a first and a second diaphragm flexure.

With this particular arrangement, a portion of the second diagram flexure can move with five degrees of freedom relative to a portion of the first diaphragm flexure. The five degrees of freedom are relative to a rectangular coordinate system having a z-axis parallel to the frame axis, and an x-axis and a y-axis mutually orthogonal with the z-axis. The five degrees of freedom include linear motion along each of the x-axis, the y-axis, and the z-axis, and rotational motion about each of the x-axis and the y-axis. Constrained degrees of freedom include rotational motion about the z-axis. The first motion stage generates substantially small direct motion errors, substantially no parasitic motion errors, and substantially no coupled motion errors.

In accordance with yet another aspect of the present invention, a second motion stage includes a first intermediate frame having a first frame axis, the first frame coupled between the inner portions of a first and a second diaphragm flexure, and a second intermediate frame coupled between the outer portions of the first and the second diaphragm flexures.

With this particular arrangement, the second intermediate frame can move with one degree of freedom relative to the first intermediate frame, the one degree of freedom relative to a rectangular coordinate system having a z-axis substantially parallel to the first frame axis, and an x-axis and a y-axis mutually orthogonal with the z-axis. The one degree of freedom is linear motion along the z-axis. Five constrained degrees of freedom include linear motion along each of the x-axis and the y-axis, and rotational motion about each of the x-axis, the y-axis, and the z-axis. The second motion stage provides a linear bearing, allowing motion along only one axis. The motion stage generates substantially small direct motion errors and substantially no parasitic motion errors.

The first, second and third couplings and the first and the second motion stages provide mechanical apparatus that have motion with only pre-determined degrees of freedom, having at least one constrained degree of freedom. The mechanical apparatus minimizes error motion in both the constrained degrees of freedom and in the unconstrained degrees of freedom.

### BRIEF DESCRIPTION OF THE DRAWINGS

The foregoing features of the invention, as well as the invention itself may be more fully understood from the following detailed description of the drawings, in which:

FIG. 1 is an isometric view of an exemplary prior art diaphragm flexure;

FIG. 1A is an isometric view of a pair of folded beams, part of the exemplary diaphragm flexure of FIG. 1;

FIG. 1B is a plan view of a diaphragm flexure is accordance with the present invention;

FIG. 2 is an isometric view of an exemplary coupling in accordance with the present invention;

FIG. 3 is an isometric view of another exemplary coupling in accordance with the present invention;

FIG. 4 is an isometric view of yet another exemplary coupling in accordance with the present invention;

FIG. 5 is an isometric view of an exemplary motion stage in accordance with the present invention;

FIG. 5A is a cross sectional view of the exemplary motion stage of FIG. 5; and

FIG. 6 is an isometric view of another exemplary motion stage in accordance with the present invention.

### DETAILED DESCRIPTION OF THE INVENTION

As described above, the six degrees of freedom of motion will be understood to be, in reference to Cartesian coordinate axes, linear motion along an x-axis, a y-axis, and a z-axis, and rotational motion about the x-axis, the y-axis, and the z-axis.

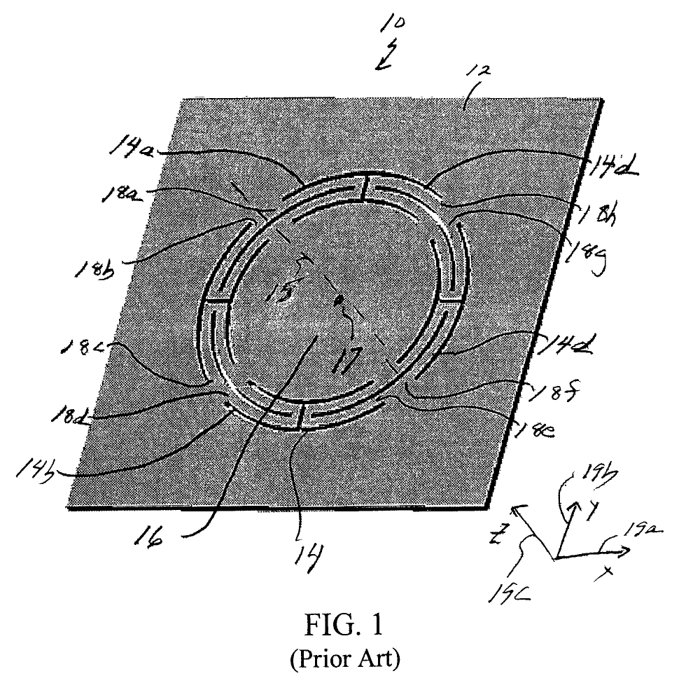

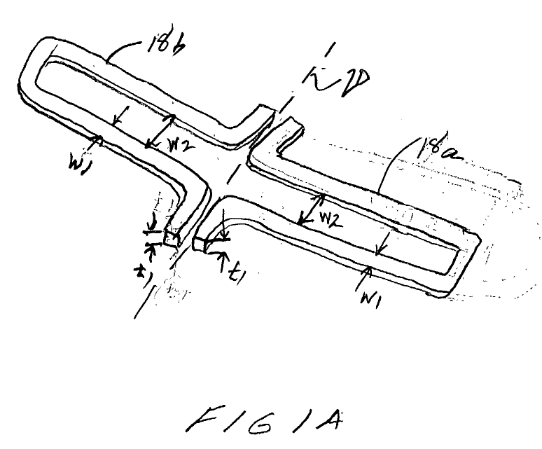

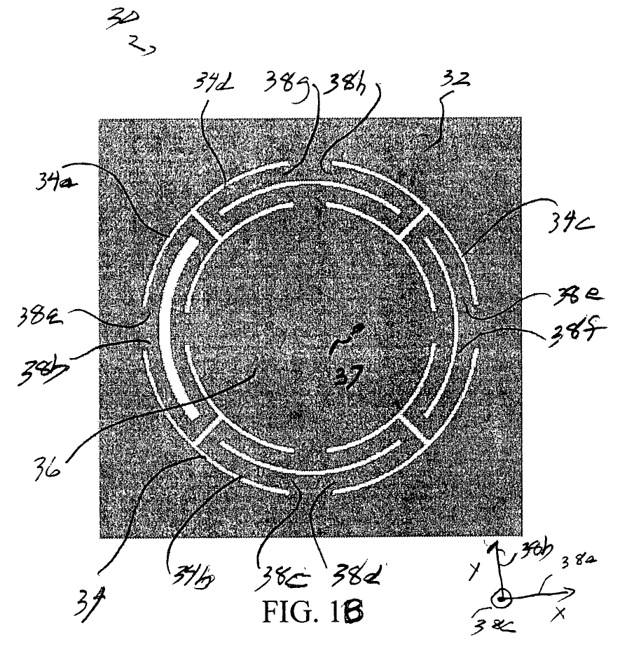

Referring now to FIG. 1, an exemplary prior art diaphragm flexure 10 includes an outer portion 12, a planar-compliant support structure 14, and an inner portion 16. The planar-compliant support structure 14 has four compliant regions 14a-14d, each having two folded beams 18a-18h, the folded beams also designated herein as folded beams 18. The folded beams 18 are further described in association with FIG. 1A. From FIG. 1A, it will become apparent that the folded beams 18a-18h can be arranged as pairs of folded beams.

The compliant regions 14a-14d are symmetrically arranged about four axes on a plane defined by an x-axis 19a and a y-axis 19b. Also, within each of the compliant regions 14a-14d, the folded beams are symmetrically arranged, for example the folded beams 18a-18b are symmetrically arranged as a pair of folded beams about an axis 15.

With this particular arrangement, the inner portion 16 can move with three unconstrained degrees of freedom relative to the outer portion 12. The three unconstrained degrees of freedom are linear motion along the z-axis 19c, and rotational motion about the x-axis 19a and the y-axis 19b. The constrained degrees of freedom, linear motion along the x-axis 19a and the y-axis 19b, and rotational motion about the z-axis 19c, are greatly constrained due to the particulars of the design of the planar-compliant support structure 14, as described below.

The symmetrical arrangement of the compliant regions and the symmetrical arrangement of each pair of folded beams results in the diaphragm flexure 10 for which motion in the constrained degrees of freedom have substantially small “direct” motion errors. Direct motion errors will be understood to be undesired motion in a constrained degree of freedom in response to a force applied in the direction of the constrained degree of freedom. For example, the inner portion 16 is constrained in rotation about the z-axis 19c, and in response to a rotational force about the z-axis 19c, movement of the inner portion 16 relative to the outer portion 12 is minimized in the constrained rotation.

Also, the diaphragm flexure 10 provides substantially no “parasitic” motion errors. Parasitic motion errors will be understood to be undesired motion in a constrained degree of freedom in response to motion in an unconstrained degree of freedom. For example, in response to movement of the inner portion 16 in any single one of or any combination of the three unconstrained degrees of freedom described above, movement of the inner portion 16 relative to the outer portion 12 in the constrained rotation is minimized.

Also, the diaphragm flexure 10 provides substantially no “coupled” motion errors. Coupled motion errors will be understood to be undesired motion in an unconstrained degree of freedom in response to motion in another unconstrained degree of freedom. For example, as the inner portion 16 is moved in rotation about the x-axis 19a, essentially no coupled motion results in rotation about the y-axis 19b or in linear motion along the z-axis 19c.

The term “center of stiffness,” as used herein, refers to the point upon the inner portion 16 at which a linear force parallel to the z-axis 19c can be applied that results in motion of the inner portion 16 in only one degree of freedom along the z-axis 19c. The center of stiffness 17 of the flexure mechanism 10 is at the center of the inner portion 16.

While each of the compliant regions 14a-14d is shown having folded beams that comprise one fold, it will be recognized that, in another embodiment of the conventional flexure (not shown), each folded beam can have more than one fold. In general, additional folds provide additional compliance.

Also, while the conventional diaphragm flexure 10 is shown having four compliant regions 14a-14d, in other conventional arrangements, a diaphragm flexure can have more than four or as few as two compliant regions. Furthermore, while a square outer portion 12 and a round inner portion 16 are shown, in other conventional arrangements, the outer portion (e.g., the outer portion 12) can be any flat shape or any three dimensional shape, and the inner portion (e.g., the inner portion 16) can be any flat or any three dimensional shape.

While the conventional diaphragm flexure 10 is shown having the folded beams 18a-18h, in other arrangements, the conventional diaphragm flexure can have unfolded (straight or curved) beams in place of the folded beams 18a-18h. The unfolded beams can be oriented either radially from the center portion 16 or tangential to the center portion 16 or at any orientation therebetween. However, an arrangement having unfolded beams generally provides a diaphragm flexure having greater motion errors, the motion errors described above, than the diaphragm flexure 10 having the folded beams 18a-18h.

It should be recognized that the planar-compliant support structure, (e.g. 14, FIG. 1), need not be perfectly flat. For example, the planar-compliant support structure 14 can be conical.

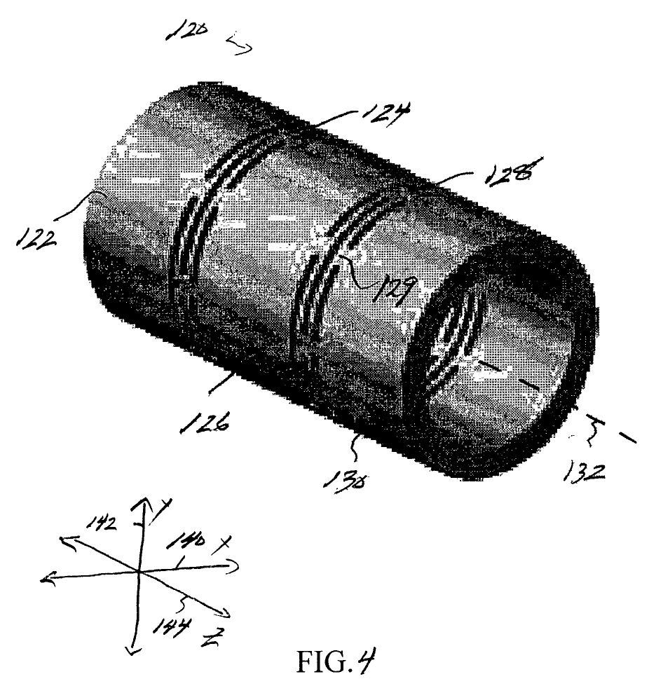

The prior art diaphragm flexure 10, having the planar-compliant support structure 14, is but one type of flexure. For example, another type of flexure, having a cylindrical-compliant support structure, is shown in FIG. 4.

Referring now to FIG. 1A, a folded beam 19a, which can be any one of the folded beams 18 of FIG. 1, has a width w1, a separation w2, and a thickness t2. The folded beam 19a has one fold corresponding to the width w2. The folded beam 19a is part of a pair of folded beams 19a, 19b, wherein the folded beam 19b is a mirror image of the folded beam 19a about an axis 20. The folded beams 19a, 19b can correspond to any of the pairs of folded beams 18a-18b, 18c, 18d, 18e-18f, and 18g-18h of FIG. 1.

Where the folded beams pairs 18a-18b, 18c-18d, 18e-18f, 18g-18h (FIG. 1) are the type of folded beams 19a-19b, the compliance of the flexure mechanism 10 (FIG. 1) is determined by a variety of factors, including, but not limited to the material of the of the folded beams 18 (FIG. 1), the shape of the folded beams 18, width w1 of the folded beams 18, the separation w2 of the folded beams 18, the thickness t1 of the folded beams 18, and the number of compliant regions 16a-16d (FIG. 1).

While each of the folded beams 19a, 19b are shown having one fold, as described above, in another arrangement, each of the folded beams can have more than one fold, therefore forming a zigzag shape. With an arrangement in which the beams have more than one fold, the compliance of a flexure mechanism (e.g., the diaphragm flexure 10 of FIG. 1), is also determined in part by the number of folds.

Referring now to FIG. 1B, an exemplary diaphragm flexure 30 in accordance with the present invention includes an outer portion 32, a planar-compliant support structure 34, and an inner portion 36. The planar-compliant support structure 34 has four compliant regions 34a-34d, each having a pair of folded beams 38a-38b, 38c-38d, 38e-38f, 38g-38h. The folded beams 38a-38h are also designated herein as folded beams 38. The folded beams 38 can be of the type described in association with FIG. 1A.

One or more compliant regions, here one compliant region 34a, have narrower width folded beams 38a-38b than others of the compliant regions 34b-34d, and a wider fold separation, where the width corresponds to the width w1 of FIG. 1A and the separation corresponds to the separation w2 of FIG. 1A. As a result, the compliance of the compliant region 34a is different than the compliance of the complaint regions 34b-34d, and the center of stiffness 37 of the flexure mechanism 30 is not at the center of the inner portion 36.

Like the diaphragm flexure 10 of FIG. 1, the inner portion 36 can move with three unconstrained degrees of freedom relative to the outer portion 32. The three unconstrained degrees of freedom are linear motion along a z-axis 38c, and rotational motion about an x-axis 38a and a y-axis 38b. The constrained degrees of freedom, linear motion along the x-axis 38a and the y-axis 38b, and rotational motion about the z-axis 38c, are greatly constrained due to the particulars of the design of the planar-compliant support structure 34, as described above.

In an alternate embodiment, in order to provide the compliant region 34a having a compliance different than others of the compliant regions 34b-34d, the folded beams 38a, 38b have a different number of folds and/or thickness (e.g., t1 of FIG. 1A) than others of the folded beams 38. With this particular alternate arrangement, a center of stiffness is also shifted away from the center of the flexure mechanism 10.

While the diaphragm flexure 30 is shown having four compliant regions 34a-34d, in another embodiment it will be recognized that a diaphragm flexure can have more than four or as few as two compliant regions. Furthermore, while a square outer portion 32 and a round inner portion 36 are shown, in other embodiment, an outer portion can be any flat shape or any three dimensional shape, and an inner portion can be any flat or three-dimensional shape. For example, the inner portion can be a cylinder.

While one compliant region 34a is shown having the folded beams 38a-38b having a different compliance than others of the folded beams 38c-38h, it will be understood that in an alternate embodiment more than one compliant region can have the different compliance. In yet another alternate embodiment, a variety of different compliances can be provided by the complaint regions 34a-34d.

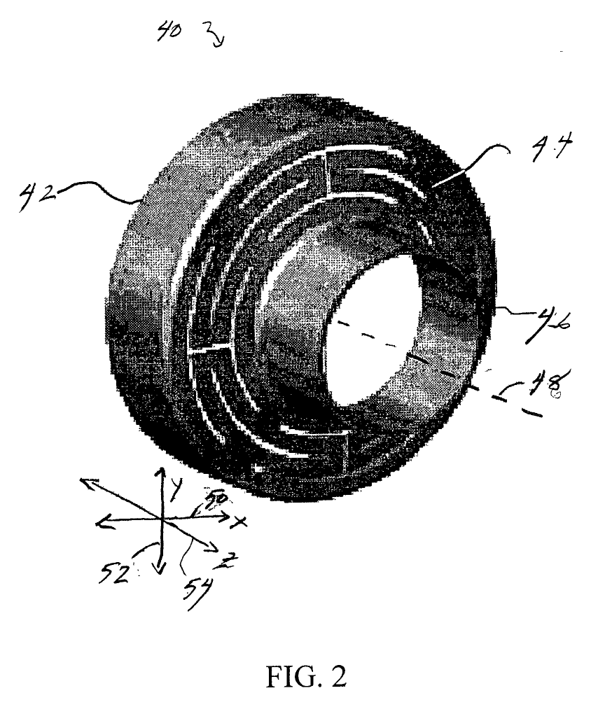

Referring now to FIG. 2, an exemplary coupling 40 includes a first coupling portion 42 having a central longitudinal axis, a second coupling portion 46 having the central longitudinal axis, a planar-compliant support structure 44 coupled between the first coupling portion 42 and the second coupling portion 46. The complaint support structure 44 can be the type of planar-compliant support structure 14, 34 described in association with FIGS. 1 and 1B respectively.

Here, the first coupling portion 42 and the second coupling portion 46 are axially aligned with each other about an axis 48. Also, the planar-compliant support structure 44 is oriented parallel to a plane substantially perpendicular to the axis 48. However, in other embodiments, the planar-compliant support structure can be at another angle with respect to the axis 48. Also, in other embodiments, one or both of the first coupling portion 42 and the second coupling portion 46 are not axially aligned with each other.

With this particular arrangement, the second coupling portion 46 can move with three degrees of freedom relative to the first coupling portion 42, the three degrees of freedom relative to a rectangular coordinate system having a z-axis axis 54 parallel to the first coupling portion axis 48. The three degrees of freedom include linear motion along the z-axis 54, and rotational motion about each of an x-axis 50 and a y-axis 52. Constrained degrees of freedom include linear motion along each of the x-axis 50 and the y-axis 52, and rotational motion about the z-axis 54. The coupling 40 generates small direct motion errors, substantially no parasitic motion errors, and substantially no coupled motion errors.

The coupling 40 can be used as a torque coupling to couple a first rotating shaft (not shown) and a second rotating shaft (not shown). In this particular application, the first rotating shaft is coupled to the first coupling portion 42, and the second rotating shaft is coupled to the second coupling portion 46. Thus, either of the first or the second rotating shafts can rotate, driven by a motor or the like, and the other of the first or the second rotating shafts will rotate in response thereto. Due to the three degrees of freedom of the exemplary coupling 40, the axis of the first coupling portion 42 and the axis of the second coupling portion 46, corresponding respectively to an axis of the first shaft and an axis of the second shaft, need not be aligned with the axis 48, and need not be aligned with each other.

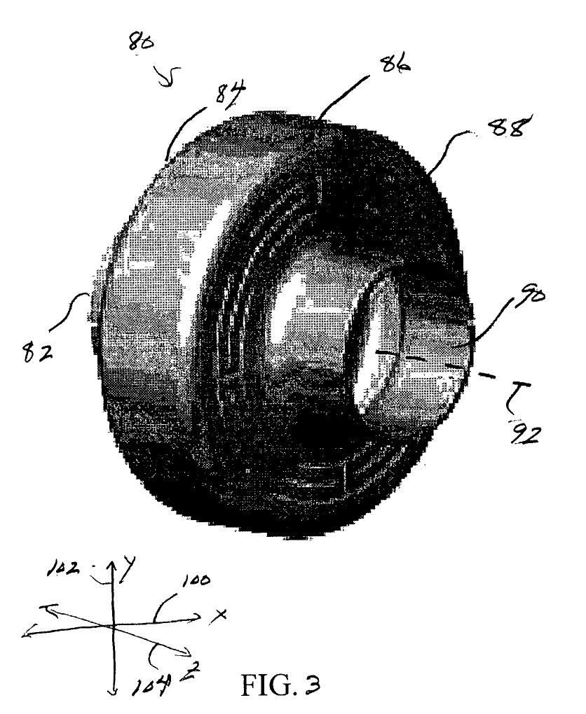

Referring now to FIG. 3, another exemplary coupling 80 includes a first coupling portion 82 having a central longitudinal axis, a first planar-compliant support structure 84 (not visible) coupled to the first coupling portion 82, and an intermediate stage 86 having a central longitudinal axis. The intermediate stage 86 is coupled between the first planar-compliant support structure 84 and a second planar-compliant support structure 88. A second coupling portion 90 having a central longitudinal axis is coupled to the second planar-compliant support structure 88. The first planar-compliant support structure 84 and the second planar-compliant support structure 88 can be the type of planar-compliant support structures 14, 34 described in association with FIGS. 1 and 1B respectively.

Here, the first coupling portion 82 and the second coupling portion 90 are axially aligned with each other about the axis 92. The intermediate stage 86 is also axially aligned with the axis 92. The first planar-compliant support structure 84 is oriented parallel to a plane substantially perpendicular to the axis 92, and the second planar-compliant support structure is oriented parallel to a another plane substantially perpendicular to the axis 92. However, in other embodiments, other alignments of the planes relative to the axis 92 are possible. Also, in other embodiments, one or more of the first coupling portion 82, the second coupling portion 90, and the intermediate stage 86 are not axially aligned with each other.

With this particular arrangement, the second coupling portion 90 can move relative to the first coupling portion 82 with five degrees of freedom. The five degrees of freedom are relative to a rectangular coordinate system having a z-axis 104 parallel to the axis 92 and an x-axis 100 and y-axis 102 mutually orthogonal with the z-axis 104. The five degrees of freedom include linear motion along each of the x-axis 100, the y-axis 102 and the z-axis 104, and rotational motion about each of the x-axis 100 and the y-axis 102. Constrained degrees of freedom include rotational motion about the z-axis 104. The coupling 80 generates small direct motion errors, substantially no parasitic motion errors, and substantially no coupled motion errors.

While one intermediate stage 86 and two planar-complaint support structures 84, 88 are shown, in other embodiments more than one or fewer than one intermediate stage 86 and more than two or fewer than two planar-complaint support structures 84, 88 can be provided. In the other embodiments an intermediate stage couples between each pair of planar-compliant support structures. The embodiment including no intermediate stage and one planar-compliant support structure is shown in FIG. 2.

Like the coupling 20 of FIG. 2, the coupling 80 can be used as a torque coupling to couple a first rotating shaft (not shown) and a second rotating shaft (not shown). In this particular application, the first rotating shaft is coupled to the first coupling portion 82, and the second rotating shaft is coupled to the second coupling portion 90. Thus, either of the first or the second rotating shafts can rotate, driven by a motor or the like, and the other of the first or the second rotating shafts will rotate in response thereto. Due to the five degrees of freedom of the exemplary coupling 80, the axis of the first cylindrical portion 82 and the axis of the second coupling portion 90, corresponding respectively to the axis of the first shaft and the axis of the second shaft, need not be aligned with the axis 92, and need not be aligned with each other.

Referring now to FIG. 4, yet another exemplary coupling 120 includes a first cylindrical portion 122, a first cylindrical-compliant support structure 124 coupled to the first cylindrical portion 122, an intermediate stage 126 coupled to the first cylindrical-compliant support structure 124, and a second cylindrical-compliant support structure coupled to the intermediate stage 126. The intermediate stage 126 is disposed between the first and the second cylindrical-compliant support structures 124, 128. A second cylindrical portion 130 is coupled to the second cylindrical-compliant support structure 128. Each of the first cylindrical portion 122, the first cylindrical-compliant support structure 124, the intermediate stage 126, the second cylindrical-compliant support structure 128, and the second cylindrical portion 130 have respective central longitudinal axes.

The first cylindrical-compliant support structure 124 and the second cylindrical-compliant support structure 128 are analogous to the planar-compliant support structures 14, 34 described in association with FIGS. 1 and 1B. Here however, folded beams of the first and second cylindrical-compliant support structures 124, 128, for example, a folded beam 129, are oriented along the z-axis 144. Like the folded beams described in association with FIGS. 1, 1A, and 1B, here the folded beams can either each have the same compliance or some of the folded beams can have a different compliance from others of the folded beams.

Both the planar-compliant support structure, (e.g., 14, 34, FIGS. 1, 1B), and the cylindrical-compliant support structure 124 are referred to herein as compliant support structures. It should be recognized that the cylindrical-compliant support structures 124, 128 need not be a perfect cylinders.

Here, the first cylindrical portion 122, the first cylindrical-compliant support structure 124, the intermediate stage 126, the second cylindrical-compliant support structure 128, and the second cylindrical portion 130 are axially aligned with each other about an axis 132. However, in other embodiments, one or more of the first cylindrical portion 122, the first cylindrical-compliant support structure 124, the intermediate stage 126, the second cylindrical-compliant support structure 128, and the second cylindrical portion 130 are not axially aligned with each other.

With this particular arrangement, the first and second cylindrical-compliant support structures 124, 128 allow the second cylindrical portion 130 to move relative to the first cylindrical portion 122 with five degrees of freedom. The five degrees of freedom are relative to a rectangular coordinate system having a z-axis 144 parallel to the axis 132 and x-axis 140 and y-axis 142 axes mutually orthogonal with the z-axis 144. The five degrees of freedom include linear motion along each of the z-axis 164, the x-axis 140 and the y-axis 142, and rotational motion about each of the x-axis 140 and the y-axis 142. Constrained degrees of freedom include rotational motion about the z-axis 144. The coupling 120 generates small direct motion errors, substantially no parasitic motion errors, and substantially no coupled motion errors

While one intermediate stage 126 and two cylindrical-complaint support structures 124, 128 are shown, in other embodiments more than one or fewer than one intermediate stage and more than two or fewer than two cylindrical-complaint support structures are provided. In the other embodiments an intermediate stage couples between each pair of cylindrical-compliant support structures. In one particular alternate arrangement, there is no intermediate stage and there is one cylindrical compliant support structure coupled between the first and the second cylindrical portions, analogous to the coupling 20 shown in FIG. 2.

Like the coupling 20 of FIG. 2 and the coupling 80 of FIG. 3, the coupling 120 can be used as a torque coupling to couple a first rotating shaft (not shown) and a second rotating shaft (not shown). In this particular application, the first rotating shaft is coupled to the first cylindrical portion 122, and the second rotating shaft is coupled to the second cylindrical portion 130. Thus, either of the first or the second rotating shafts can rotate, driven by a motor or the like, and the other of the first or the second rotating shafts will rotate in response thereto. Due to the five degrees of freedom of the exemplary coupling 120, the axis of the first cylindrical portion 122 and the axis of the second cylindrical portion 130, corresponding respectively to the axis of the first shaft and the axis of the second shaft, need not be aligned with the axis 132, and need not be aligned with each other.

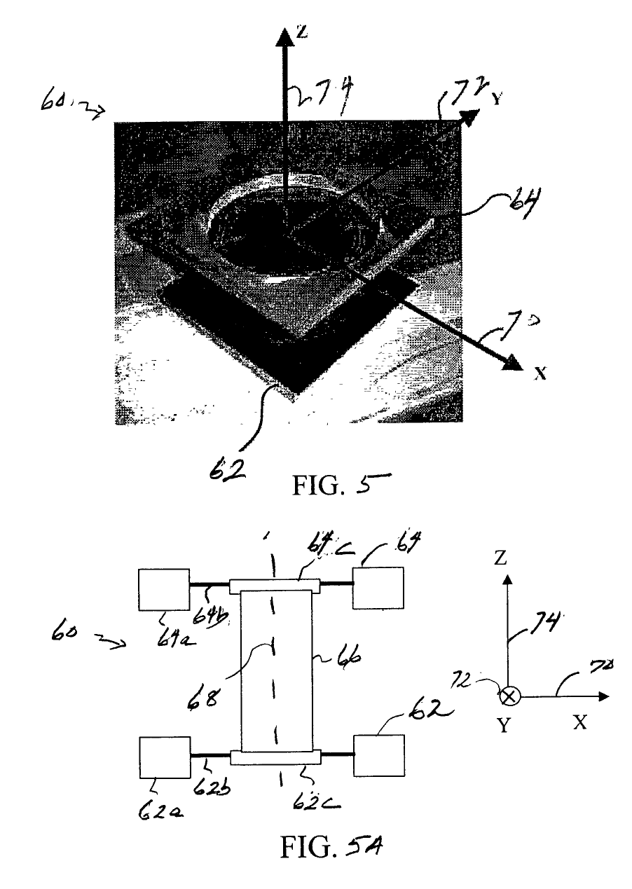

Referring now to FIGS. 5 and 5A, in which like elements are labeled with like reference designations, an exemplary motion stage 60 includes a first diaphragm flexure 62 and a second diaphragm flexure 64. The first diaphragm flexure 62 has a first outer portion 62a, a first planar-compliant support structure 62b and a first inner portion 62c. The second diaphragm flexure 64 has a second outer portion 64a, a second planar-compliant support structure 64b, and a second inner portion 64c. An intermediate frame 46 having a central longitudinal axis axially aligned with an axis 68 is coupled between the first inner portion 62c and the second inner portion 64c. The first diaphragm flexure 62 and the second diaphragm flexure 64 can be the type of diaphragm flexure 10, 30 described in association with FIGS. 1 and 1B respectively.

Here, the first diaphragm 62 is oriented parallel to a first flexure plane, the second diaphragm flexure 64 is oriented parallel to a second flexure plane and the first and the second flexure planes are substantially parallel. Here also, the first and second flexure planes are substantially perpendicular to the axis 68. However, in other embodiments, one or both of the first and the second flexure planes are not parallel and they are not perpendicular to the axis 68.

With this particular arrangement, the outer portion 64a of the second diagram flexure 64 can move with five degrees of freedom relative to the outer portion 62a of the first diaphragm flexure 62. The five degrees of freedom are relative to a rectangular coordinate system having a z-axis 74 parallel to the frame axis 68, and an x-axis 70 and a y-axis 72 mutually orthogonal with the z-axis 74. The five degrees of freedom include linear motion along each of the x-axis 70, the y-axis 72, and the z-axis 74, and rotational motion about each of the x-axis 70 and the y-axis 72. Constrained degrees of freedom include rotational motion about the z-axis 74. The motion stage 60 generates small direct motion errors, substantially no parasitic motion errors, and substantially no coupled motion errors.

In another alternate embodiment, the intermediate frame 66 is coupled between the first outer portion 62a, and the second outer portion 64a. For this alternate embodiment, the inner portion 64c of the second diaphragm flexure 64 can move relative to the inner portion 62c of the first diaphragm flexure 62 with the same five degrees of freedom and the same constrained degree of freedom described above.

While a cylindrical intermediate frame 66 is shown, in other embodiments, the intermediate frame can have any three dimensional shape.

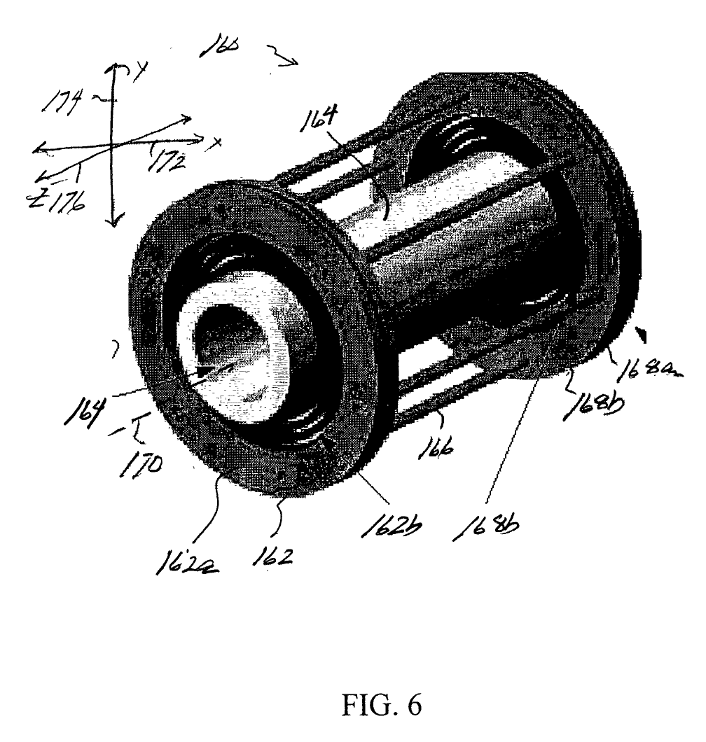

Referring now to FIG. 6, an exemplary motion stage 160 includes a first diaphragm flexure 162 having a first outer portion 162a and a first planar-compliant support structure 162b, a second diaphragm flexure 168 having a second outer portion 168a and a second planar-compliant support structure 168b. A first intermediate frame 166 having a central longitudinal axis is coupled between the first outer portion 162a and the second outer portion 168a. A second intermediate frame 164 having a central longitudinal axis is coupled between the first planar-compliant support structure 162a. The first planar-compliant support structure 162b and the second planar-compliant support structure 168b can be the type of planar-compliant support structure 14, 24, 34 described in association with FIGS. 1, 1A, and 1B.

Here, the axis of the first intermediate frame 164 and the axis of the second intermediate frame 162 are shown to be axially aligned with each other about an axis 170. Also, the first diaphragm flexure 162 is shown to be oriented substantially parallel to the second flexure 164, each diaphragm flexure 162, 164 aligned in a respective flexure plane. Here also, the first and the second diaphragm flexures 162, 164, are shown to be substantially perpendicular to the axis 170. However, in other embodiments, one or both of first and the second diaphragm flexures 162, 164 are not perpendicular to the axis 170. Also, in other embodiments, the first and the second intermediate frames 164, 166 are not axially aligned with each other.

With this particular arrangement, the second intermediate frame 164 can move with one degree of freedom relative to the first intermediate frame 166, the one degree of freedom relative to a rectangular coordinate system having a z-axis 176 substantially parallel to the axis 170 and an x-axis 172 and a y-axis 174 mutually orthogonal with the z-axis 176. Thus, the one degree of freedom includes linear motion along the z-axis 176. Constrained degrees of freedom include linear motion along each of the x-axis 172 and the y-axis 174, and rotational motion about each of the x-axis 172, the y-axis 174, and the z-axis 176. The motion stage 160 provides a linear bearing, allowing motion along only one axis. Thus, the motion stage 160 generates small direct motion errors, substantially no parasitic motion errors, and substantially no coupled motion errors.

While the first intermediate frame 166 is shown to be a hollow cylinder, in other embodiments, the first intermediate frame 164 can be any hollow or solid three-dimensional shape. Also, while the second intermediate frame 166 is comprised of a plurality of bars, in other embodiments, the second intermediate frame 166 can be any hollow three-dimensional shape.

All references cited herein are hereby incorporated herein by reference in their entirety.

Having described preferred embodiments of the invention, it will now become apparent to one of ordinary skill in the art that other embodiments incorporating their concepts may be used. It is felt therefore that these embodiments should not be limited to disclosed embodiments, but rather should be limited only by the spirit and scope of the appended claims.

What is claimed is:

1. A coupling comprising:
a first coupling portion having a first coupling portion axis;
a compliant support structure coupled to the first coupling portion; and
a second coupling portion coupled to the compliant support structure, the second coupling portion having a second coupling portion axis, wherein the second coupling portion can move relative to the first coupling portion with pre-determined degrees of freedom, the degrees of freedom relative to a rectangular coordinate system having a third coordinate axis parallel to the first coupling portion axis and first and second coordinate axes mutually orthogonal with the third coordinate axis.

2. The coupling of claim 1, wherein the compliant support structure is a planar-compliant support structure.

3. The coupling of claim 2, wherein the planar-compliant support structure is oriented in a support structure plane substantially perpendicular to the first coupling portion axis, the second coupling portion axis substantially parallel to the first coupling portion axis.

4. The coupling of claim 1, wherein the compliant support structure is a cylindrical-compliant support structure.

5. The coupling of claim 4, wherein the cylindrical-compliant support structure has a support structure axis, the support structure axis substantially parallel to the first coupling portion axis, the second coupling portion axis substantially parallel to the first coupling portion axis.

6. The coupling of claim 1, wherein the compliant support structure includes at least two compliant regions.

7. The coupling of claim 6, wherein each of the at least two compliant regions includes at least one pair of folded beams that can elastically deform.

8. The coupling of claim 6, wherein the compliant support structure has symmetry about at least two axes.

9. The coupling of claim 6, wherein at least one of the at least two compliant regions has a compliance different from others of the at least two compliant regions.

10. The coupling of claim 1, wherein the compliant support structure includes at least four compliant regions.

11. The coupling of claim 10, wherein each of the at least four compliant regions includes at least one pair of folded beams that can elastically deform.

12. The coupling of claim 10, wherein the compliant support structure has symmetry about at least four axes.

13. The coupling of claim 10, wherein at least one of the at least four compliant regions has a compliance different from others of the at least four compliant regions.

14. The coupling of claim 1, wherein the pre-determined degrees of freedom include linear motion along the third coordinate axis and rotational motion about the first an the second coordinate axes, and wherein the motion of the second coupling portion relative to the first coupling portion is constrained in three other degrees of freedom, wherein one of the constrained degrees of freedom is rotation about the third coordinate axis.

15. A coupling comprising:
one or more intermediate stages;
two or more planar-compliant support structures, each of the one or more intermediate stages coupled between two of the two or more planar-compliant support structures, each of the two or more planar-compliant support structures oriented in a respective support structure plane;
a first coupling portion coupled to one of the two or more planar-compliant support structures, the first coupling portion having a first coupling portion axis; and
a second coupling portion coupled to another one of the two or more planar-compliant support structures, the second coupling portion having a second coupling portion axis, wherein the second coupling portion can move relative to the first coupling portion with pre-determined degrees of freedom, the degrees of freedom relative to a rectangular coordinate system having a third coordinate axis parallel to the first coupling portion axis and first and second coordinate axes mutually orthogonal with the third coordinate axis.

16. The coupling of claim 15, wherein the respective support structure planes are substantially parallel, the respective support structure planes substantially perpendicular to the first coupling portion axis, and the second coupling portion axis is substantially parallel to the first coupling stage axis.

17. The coupling of claim 15, wherein each of the two or more planar-compliant support structures includes at least two respective compliant regions.

18. The coupling of claim 17, wherein each of the at least two respective compliant regions includes at least one pair of folded beams that can elastically deform.

19. The coupling of claim 17, wherein each of the two or more planar-compliant support structures have symmetry about at least two respective axes on the respective support structure plane.

20. The coupling of claim 17, wherein at least one of the at least two respective compliant regions has a different compliance than others of the at least two respective compliant regions.

21. The coupling of claim 15, wherein each of the two or more planar-compliant support structures includes at least four respective compliant regions.

22. The coupling of claim 21, wherein each of the at least four respective compliant regions includes at least one pair of folded beams that can elastically deform.

23. The coupling of claim 21, wherein each of the two or more planar-compliant support structures have symmetry about at least four respective axes on the respective support structure plane.

24. The coupling of claim 21, wherein at least one of the at least four respective compliant regions has a different compliance than others of the at least four respective compliant regions.

25. The coupling of claim 15, wherein the pre-determined degrees of freedom include linear motion in the first, second and third coordinate axes, and rotational motion about the first and the second coordinate axes, and wherein the motion of the third coupling portion relative to the first coupling portion is constrained in rotation about the third coordinate axis.

26. A coupling comprising:
one or more intermediate stages, each having a respective intermediate stage axis;
two or more cylindrical-compliant support structures, each of the one or more intermediate stages coupled between two of the two or more cylindrical-compliant support structures, each of the two or more cylindrical-compliant support structures having a respective cylindrical-compliant support structure axis;
a first cylindrical portion coupled to one of the two or more cylindrical-compliant support structures, the first cylindrical portion having a first cylindrical portion axis; and
a second cylindrical portion coupled to another one of the two or more cylindrical-compliant support structures, the second cylindrical portion having a second cylindrical portion axis, wherein the second cylindrical portion can move relative to the first cylindrical portion with pre-determined degrees of freedom, the degrees of freedom relative to a rectangular coordinate system having a third coordinate axis parallel to the first cylindrical portion axis and first and second coordinate axes mutually orthogonal with the third coordinate axis.

27. The coupling of claim 26, wherein the second cylindrical portion axis is substantially parallel to the first cylindrical portion axis, each respective intermediate stage axis is substantially parallel to the first cylindrical portion axis, and each of the respective cylindrical-compliant support structure axes are substantially parallel to the first cylindrical portion axis.

28. The coupling of claim 26, wherein each of the two or more cylindrical-compliant support structures includes at least two respective compliant regions.

29. The coupling of claim 28, wherein each of the at least two respective compliant regions includes at least one pair of folded beams that can elastically deform.

30. The coupling of claim 28, wherein each of the two or more cylindrical-compliant support structures have symmetry about at least two respective axes, each of the at least two respective axes perpendicular to the respective cylindrical-compliant support structure axis.

31. The coupling of claim 28, wherein at least one of the at least two respective compliant regions has a compliance different from others of the at least two respective compliant regions.

32. The coupling of claim 26, wherein each of the two or more cylindrical-compliant support structures includes at least four respective compliant regions.

33. The coupling of claim 32, wherein each of the at least four respective compliant regions includes at least one pair of folded beams that can elastically deform.

34. The coupling of claim 32, wherein each of the two or more cylindrical-compliant support structures have symmetry about at least four respective axes, each of the at least four respective axes perpendicular to the respective cylindrical-compliant support structure axis.

35. The coupling of claim 32, wherein at least one of the at least four respective compliant regions has a compliance different from others of the at least four respective compliant regions.

36. The coupling of claim 26, wherein the pre-determined degrees of freedom include linear motion in the first, second and third axes, and rotational motion about the first and the second axes, and wherein the motion of the third cylindrical portion relative to the first cylindrical portion is constrained in rotation about the third coordinate axis.

37. A motion stage, comprising:
a first diaphragm flexure oriented parallel to a first flexure plane;
a second diaphragm flexure oriented parallel to a second flexure plane; and
an intermediate frame coupled between the first diaphragm flexure and the second diaphragm flexure, the intermediate frame having an intermediate frame axis, wherein a portion of the second diaphragm flexure can move with pre-determined degrees of freedom relative to a portion of the first diaphragm flexure, the degrees of freedom relative to a rectangular coordinate system having a third coordinate axis perpendicular to the first flexure plane and first and second coordinate axes mutually orthogonal with the third coordinate axis.

38. The motion stage of claim 37, wherein the second flexure plane is substantially parallel to the first flexure plane and the intermediate frame axis is substantially perpendicular to the first and the second flexure planes.

39. The motion stage of claim 37, wherein each of the first and the second diaphragm flexures includes at least two respective compliant regions.

40. The motion stage of claim 39, wherein each of the at least two respective compliant regions include at least one pair of folded beams that can elastically deform.

41. The motion stage of claim 39, wherein the first diaphragm flexure has symmetry about at least two axes on the first flexure plane and the second diaphragm flexure has symmetry about at least two axes on the second flexure plane.

42. The motion stage of claim 39, wherein at least one of the at least two respective compliant regions has a compliance that is different than others of the at least two compliant regions.

43. The motion stage of claim 37, wherein each of the first and the second diaphragm flexures includes at least four respective compliant regions.

44. The motion stage of claim 43, wherein each of the at least four respective compliant regions includes at least one pair of folded beams that can elastically deform.

45. The motion stage of claim 43, wherein the first diaphragm flexure has symmetry about at least four axes on the first flexure plane and the second diaphragm flexure has symmetry about at least four axes on the second flexure plane.

46. The motion stage of claim 43, wherein at least one of the at least four respective compliant regions has a compliance that is different than others of the at least four compliant regions.

47. The motion stage of claim 37, wherein the pre-determined degrees of freedom include linear motion in the first, second and third coordinate axes, and rotational motion about the first and the second coordinate axes, and wherein the motion of the second diaphragm flexure relative to the first diaphragm flexure is constrained in rotation about the third coordinate axis.

48. The motion stage of claim 37, wherein the intermediate frame is stiff in all axes.

49. A motion stage, comprising:
a first diaphragm flexure oriented parallel to a first flexure plane, the first diaphragm flexure having a first outer portion and a first inner portion;
a second diaphragm flexure oriented parallel to a second flexure plane, the second diaphragm flexure having a second outer portion and a second inner portion;
a first intermediate frame coupled between the first outer portion and the second outer portion, the first intermediate frame having a first intermediate frame axis; and an second intermediate frame coupled between the first inner portion and the second inner portion, the second intermediate frame having a second intermediate frame axis, wherein the second intermediate frame can move relative to the first intermediate frame with pre-determined degrees of freedom, the degrees of freedom relative to a rectangular coordinate system having a third coordinate axis substantially parallel to the second intermediate frame axis and first and second coordinate axes mutually orthogonal with the third coordinate axis.

50. The motion stage of claim 49, wherein the second flexure plane is substantially parallel to the first flexure plane, the first intermediate frame axis is substantially perpendicular to the first and the second flexure planes, and the second intermediate frame axis is substantially parallel to the first intermediate frame axis.

51. The motion stage of claim 49, wherein each of the first and the second diaphragm flexures includes at least two respective compliant regions.

52. The motion stage of claim 51, wherein each of the at least two respective compliant regions includes at least one pair of folded beams that can elastically deform.

53. The motion stage of claim 51, wherein the first diaphragm flexure has symmetry about at least two axes on the first flexure plane and the second diaphragm flexure has symmetry about at least two axes on the second flexure plane.

54. The motion stage of claim 49, wherein each of the first and the second diaphragm flexures includes at least four respective compliant regions.

55. The motion stage of claim 54, wherein each of the at least four respective compliant regions include at least one pair of folded beams that can elastically deform.

56. The motion stage of claim 54, wherein the first diaphragm flexure has symmetry about at least four axes on the first flexure plane and the second diaphragm flexure has symmetry about at least four axes on the second flexure plane.

57. The motion stage of claim 49, wherein the pre-determined degrees of freedom include linear motion along the third coordinate axis, and wherein the motion of the second intermediate frame relative to the first intermediate frame is constrained in linear motion along the first and second coordinate axes, and in rotational motion about the first, second, and third coordinate axes.

58. The motion stage of claim 49, wherein the first and the second intermediate frames are stiff in all axes.

59. A flexure, comprising;
an inner portion
and outer portion; and
a compliant support structure coupled between said inner and said outer portions, wherein said compliant support structure comprises as least two compliant regions, each compliant region having at least one pair of folded beams, at least one of the at least one pair of folded beams having a different compliance than others of the at least one pair of folded beams.
